(19) United States
(12) Patent Application Publication
(10) Pub. No.: US 2018/0192498 A1
(43) Pub. Date: Jul. 5, 2018

(54) ENVIRONMENTAL MANAGEMENT DEVICE, SYSTEM AND METHOD THEREOF

(71) Applicant: Hung-Li LIN, Taipei City (TW)

(72) Inventor: Hung-Li LIN, Taipei City (TW)

(21) Appl. No.: 15/786,011

(22) Filed: Oct. 17, 2017

(30) Foreign Application Priority Data
Dec. 30, 2016 (TW) 105220111

(51) Int. Cl. H05B 37/02

(52) U.S. Cl. CPC H05B 37/0254; H05B 37/0272

(57) ABSTRACT

An environmental management device includes a network connection port for receiving a first pulse width modulation signal via an Internet; and a plurality pulse width modulation connection ports coupled electrically with the network connection port, each pulse width modulation connection port being used for receiving the first pulse width modulation signal in order to control at least one brightness of at least one LED, at least two modulation connection ports of the plurality pulse width modulation connection ports being used to control at least one color temperature of the at least one LED, wherein the Internet is selected from a group consisting of at least one cable network, at least one wireless network, and a combination thereof. The present invention also provides an environmental management method.

### CROSS-REFERENCE TO RELATED APPLICATION

This application claims the priority of Taiwanese patent application No. 105220111, filed on Dec. 30, 2016, which is incorporated herewith by reference.

### BACKGROUND OF THE INVENTION

### 1. Field of the Invention

The present invention relates to an environmental management device, system and method thereof, more particularly to an environmental management device, system and method that can be monitored from a distal end remotely via an Internet.

### 2. The Prior Arts

In recent years, light-emitting diode (LED) is booming. Not only the manufacturing technology of LED has been fully developed, but also LED has sufficient luminance as a light source of illumination. As the LED has power saving, small size, long life, low residual light and high light response and other characteristics, more LEDs are accepted by the market, and there's a trend to replace traditional bulb.

Taiwan patent publication No. 1577239 has disclosed “Energy-saving dimmable LED bulb with environmental illumination adjusting function”, which includes an LED module; an electric switch for supplying A/C current to switch On and Off of the LED module; a current converter for transforming the A/C current to the direct current when the electric switch is switched ON; a charging unit coupled electrically with the current converter for charging the current converter with the direct current when the electric switch is switched ON; a controller coupled electrically with the current converter and having a timer for electrically coupled with the charger unit such that the timer can detect cycling numbers of switch-ON and switch-OFF operations. The charger supplies the direct current to the controller and the timer when the electric switch is switched OFF while the controller is coupled electrically with the LED in order to adjust the brightness of the LED in accordance with the cycling numbers of switch-ON and switch-OFF operations.

Taiwan patent publication No. I574608 has disclosed “Light distribution verification platform for plant factory”, which includes a power source converter having two input terminals coupled electrically with positive and negative ends of an input voltage; a voltage output end for providing a variable output voltage; a red sync signal output end for proving a red sync signal; a green sync signal output end for providing a green sync signal; and a blue sync signal output end for providing a blue sync signal, wherein the variable output voltage exhibits a first voltage when the red sync signal is at an active potential, the green sync signal or the blue sync signal exhibits a second voltage in an active potential; a RGB LED circuit having a string of red LEDs, a first switch connected with the string of red LEDs in serial, a string of green LEDs, a second switch connected with the string of green LEDs in serial, a string of blue LEDs, a third switch connected with the string of blue LEDs in serial; and a constant current unit, wherein the electrical power for the string of red LEDs and the string of blue LEDs are supplied by the variable output voltage, the first switch is controlled by the first driving signal, the second switch is controlled by the second driving signal while the third switch is controlled by the third driving signal. The first, second and third switches are connected electrically with a reference parameters via the constant current unit such that the latter provides a constant current thereto, wherein a first average current that passes through the string of red LEDs is equivalent to a multiplication of the constant current and responsible ratio of the first driving signal; a second average current that passes through the string of green LEDs is equivalent to a multiplication of the constant current and responsible ratio of the second driving signal while a third current that passes through the string of blue LEDs is equivalent to a multiplication of the constant current and responsible ratio of the third driving signal; a light sensitive unit for detecting the output light beams of the string of red LEDs, the string of green LEDs and the string of blue LEDs for generating a red light sensing signal, a green light sensing signal and a blue light sensing signal; and a controller installed with a firmware program for executing a driving signal generation procedure based on the first, second and third driving signals, wherein the driving signal generation procedure includes scale-integration-differential operation, when the first, second and third average currents generated by the driving signal generation procedure are less than a threshold current, the scale-integration-differential operation is conducted under a first executive mode, when any one of the first, second and third average currents is greater than the threshold current, the scale-integration-differential operation is conducted under a second executive mode; wherein when the controller operates under the first executive mode, the scale-integration-differential operations of the driving signal generation procedure is conducted based on a preset red light reference value and the red light sensing signal, a preset green light reference value and the green light sensing signal, and a preset blue light reference value and the blue light sensing signal; wherein when the controller operates under the second executive mode, the minimum ratio is find out from the ratio values between the threshold current of the driving signal generation procedure and the first average current, the threshold current and the second average current and the threshold current and the third average current, after which the minimum ratio is multiplied with the preset red light reference value in order to achieve an adjusted red light reference value; the minimum ratio is multiplied with the preset green light reference value in order to obtain an adjusted green light value; and the minimum ratio is multiplied with the preset blue light reference value in order to obtain an adjusted blue light reference value. Later, the scale-integration-differential operation is conducted based on the adjusted red light reference value and the red light sensing signal; the scale-integration-differential operation is conducted based on the adjusted green reference value and the green light sensing signal; and the scale-integration-differential operation is conducted based on the adjusted blue light reference value and the blue light sensing signal.

Another Taiwan patent No. M538573 has disclosed “Automatic management system for LED module”, which includes an LED unit, at least one fan unit, at least one light sensitive element and a controller. The LED unit includes a plurality of LED chips. The fan unit is disposed at one side corresponding to the LED unit for dissipating the heat generated therefrom. The light sensitive element is disposed adjacent to the LED unit in order to detect the brightness of the LED unit so as to generate a light sensing signal. The controller includes a microprocessor, a power source management unit and an interface circuit coupled respectively to the fan unit, the light sensitive element and the microprocessor such that the microprocessor generates a control signal based on the light sensing signal. The power source management unit is connected electrically to the microprocessor, the LED unit and the fan unit such that upon receiving the control signal, the power source management unit effectively adjusts the brightness of the LED unit so as to achieve the uniform brightness.

However, in the aforementioned techniques, the brightness or color temperature of a relatively large area cannot be controlled from a remote end and hence the consumed electrical power and the corresponding data cannot be detected. Moreover, the environment of the LED lighting or the electrical power source cannot be managed from the distal end via a program, a timer of a server or the Internet.

Therefore, the objective of the present invention is to provide an environmental management device, system and method, in which a pulse width modulation signal is utilized via the Internet so as to monitor and control at least one of the brightness and the color temperature of the environment and a combination thereof such that the lighting of the environment can be maintained or monitored from a distal end at a low cost.

### SUMMARY OF THE INVENTION

A primary objective of the present invention is to provide an environmental management device, system and method, in which a pulse width modulation signal is utilized via the Internet so as to monitor and control at least one of the brightness and the color temperature of the environment and a combination thereof such that the lighting of the environment can be maintained from a distal end at a low cost.

In order to achieve the aforesaid the objective, an environmental management device of the present invention includes: a network connection port for receiving a first pulse width modulation signal via the Internet; and a plurality pulse width modulation connection ports coupled electrically with the network connection port, each pulse width modulation connection port is used for receiving the first pulse width modulation signal in order to control at least one brightness of at least one LED, at least two modulation connection ports of the plurality modulation connection ports are used to control a color temperature of the at least one LED, wherein, the Internet is selected from a group consisting of a cable network and a wireless network or a combination of the two.

In order to achieve the aforesaid objective, an environmental management system of the present invention includes: a network connection port for receiving a first pulse width modulation signal via the Internet; a plurality pulse width modulation connection ports coupled electrically with the network connection port, each pulse width modulation connection port is used for receiving the first pulse width modulation signal in order to control at least one brightness of at least one LED, at least two pulse width modulation connection ports of the plurality pulse width modulation connection ports are used to control a color temperature of the at least one LED; a background management module for generating the first pulse width modulation signal; and at least one sensor for generating monitoring data adapted to be acquired by the background management module via one of the plurality pulse width modulation connection ports; wherein, the Internet is selected from a group consisting of at least one cable network, at least one wireless network and a combination thereof

To eliminate the prior disadvantages, an environmental management method of the present invention includes: an operator operating in such a manner to generate a first pulse width modulation signal; receiving the first pulse width modulation signal through the Internet in order to control at least one brightness and at least one color temperature of at least one LED; and acquiring at least one monitoring data.

When utilizing the environmental management system of the present invention, the operator prepares the background management module adapted to be operated to generate the first pulse width modulation signal, after which the network connection port receives the first pulse width modulation signal via the Internet and is later transmitted to the plurality of pulse width modulation signal connection ports such that each pulse width modulation signal connection port is used for controlling at least one brightness of at least one LED while at least two pulse width modulation connection ports of the plurality pulse width modulation connection ports are used to control at least one color temperature of the at least one LED. Then, the background management module captures and monitors the at least one monitoring data generated by the at least one sensor through the plurality of pulse width modulation ports.

A user can easily remote control at least one of brightness and color temperature of the environment and a combination thereof and can further remote monitor an environmental data. Further, the maintenance cost of the ambient light source can be reduced.

### BRIEF DESCRIPTION OF THE DRAWINGS

FIG. 1 is a block diagram illustrating the elements constituting an environmental management system according to the present invention;

FIG. 2 illustrates how at least two pulse width modulation connection ports are connected electrically to at least one LED unit in order to control the color temperature of the LED unit according to the present invention;

FIG. 3 shows a block diagram illustrating a plurality of digital switches in the environmental management system according to the present invention;

FIG. 4 shows a block diagram illustrating the environmental management system according to the present invention connected to connection ports of other electronic devices; and

FIG. 5 illustrates the environmental management system according to the present invention in real application.

### DETAILED DESCRIPTION OF THE PREFERRED EMBODIMENT

Hereinafter, embodiments of the present invention will be described with specific embodiments, and those skilled in the art will readily appreciate the other advantages and effects of the present invention by what is described in this specification. The present invention may also be embodied or modified by other specific examples, and various modifications and variations of the present invention may be made without departing from the spirit and scope of the invention.

The structures, proportions, sizes, etc. shown in the drawings are intended to be used in conjunction with the description as set forth in the description and are not to be construed as being limited to those skilled in the art and are not intended to limit the scope of the invention The modification of the structure, the modification of the structure, the change of the proportionality, or the adjustment of the size of the structure shall be carried out without affecting the effect and the purpose of the invention. Reveal the technical content can be covered within the scope.

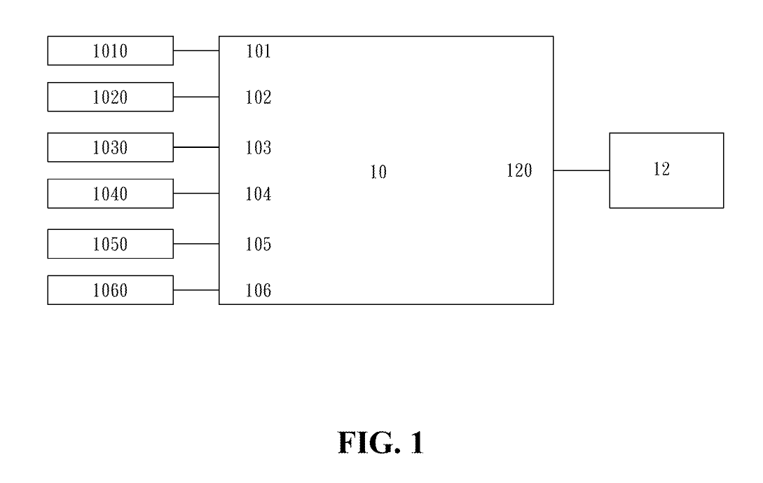

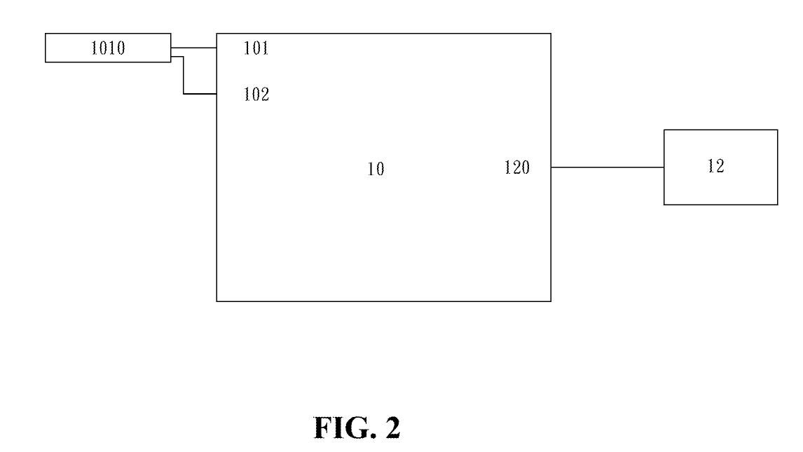

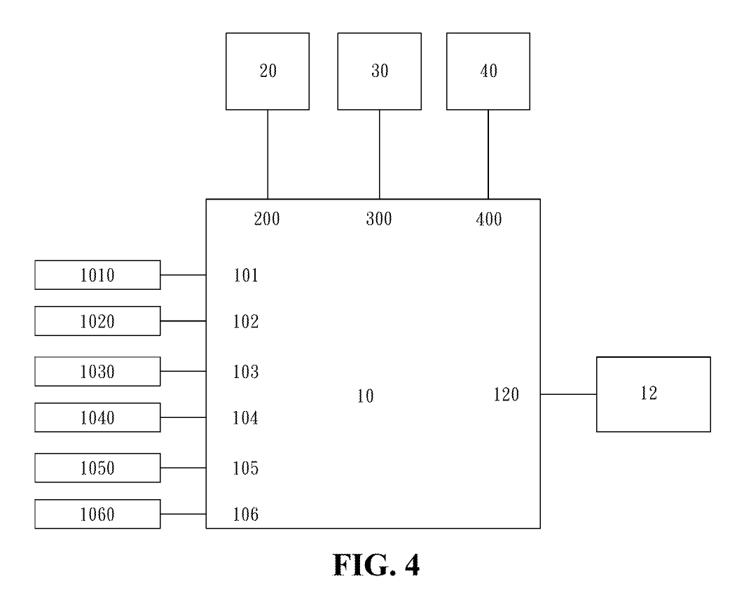

Referring to FIGS. 1 to 4, an environmental management device and system will be described below with reference to an embodiment of the present invention.

As shown, an environmental management device 10 according to the present invention includes: a network connection port 120 for receiving a first pulse width modulation signal (not visible) via the Internet for performance of pulse width modulation; and a plurality pulse width modulation connection ports 101, 102, 103, 104, 105, 106 coupled electrically with the network connection port 120, each pulse width modulation connection port 101, 102, 103, 104, 105, 106 is used for receiving the first pulse width modulation signal in order to control at least one brightness of at least one LED unit , at least two modulation connection ports of the plurality pulse width modulation connection ports 101, 102, 103, 104, 105, 106 are used to control at least one color temperature of the at least one LED, wherein, the Internet is selected from a group consisting of at least one cable network, at least one wireless network and a combination thereof

The environmental management device of the present invention further includes a background management module 12 that can be operated by at least one operator (not visible) for generating the first pulse width modulation signal.

Further, the background management module 12 is adapted to be operated by the at least one operator to generate a timing command (not visible) such that performance of the at least one LED unit 1010, 1020, 1030, 1040, 1050, 1060 is controlled by the first pulse width modulation signal based on the timing command.

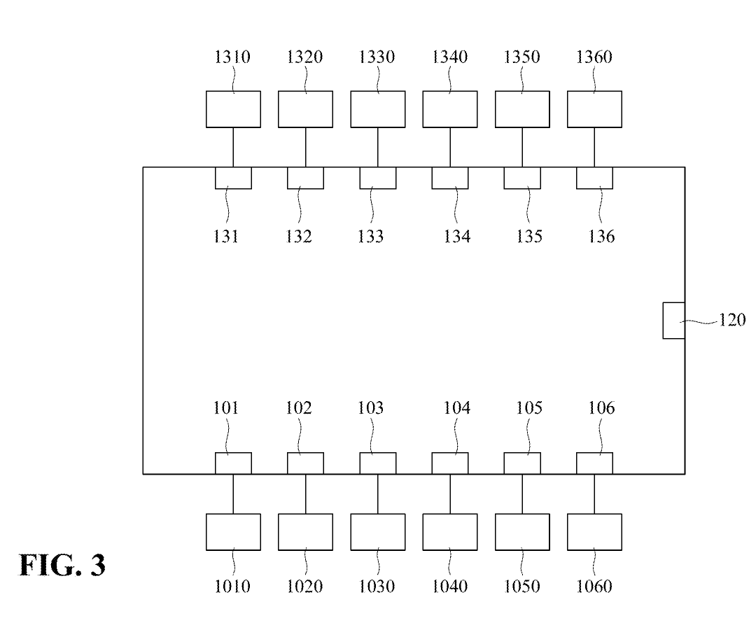

The environmental management device 10 of the present invention further includes a plurality of digital switch ports 131, 132, 133, 134, 135, 136 (see FIG. 3) and a plurality of digital switches 1310, 1320, 1330, 1340, 1350, 1360 coupled electrically and respectively to the plurality of digital switch ports 131, 132, 133, 134, 135, 136, each of the plurality of digital switch ports 131, 132, 133, 134, 135, 136 is used for receiving a second pulse width modulation signal (not visible) generated by each of the plurality of digital switches 1310, 1320, 1330, 1340, 1350, 1360 for conducting the pulse width modulation.

Note that each pulse width modulation connection port 101, 102, 103, 104, 105, 106 is used for receiving the second pulse width modulation signal in order to control the at least one brightness of at least one LED unit 1010, 1020, 1030, 1040, 1050, 1060, at least two modulation connection ports of the plurality pulse width modulation connection ports 101, 102, 103, 104, 105, 106 are used to receive the second pulse width modulation signal to control at least one color temperature of the at least one LED 1010, 1020, 1030, 1040, 1050, 1060.

The plurality pulse width modulation connection ports 101, 102, 103, 104, 105, 106 have several specifications comprising at least one of a digital dimming port 200, a PIR object movement sensing port 300, RS485, RS422, RS232, UART, CAN, LIN and I2C and a combination thereof

In one embodiment of the present invention, one pulse width modulation connection port 101, 102, 103, 104, 105, 106 compatible with one specification RS485, RS422, RS232, UART, CAN, LIN and I2C can be coupled electrically with a connection port of at least one sensor 40 that is compatible with one specification RS485, RS422, RS232, UART, CAN, LIN and I2C to form a sensing connection port 400 such that the background management module 12 can acquire the monitoring data (like power consumption, immediate brightness, immediate color temperature and control temperature) generated from the at least one sensor 40 through the pulse width modulation connection ports 101, 102, 103, 104, 105, 106.

In this embodiment, the digital dimming port 200 is coupled electrically with the digital dimmer 20; the PIR object movement sensing port 300 is coupled with the PIR object movement sensor 30 while the sensing connection port 400 is coupled electrically with the at least one sensor 40.

One aspect to note is that a desktop server for controlling a computer or a mobile phone can serve as the background management module 12 that is coupled electrically the LEDs 1010, 1020, 1030, 1040, 1050, 1060 and the sensor 40 via the SNMP (Simple Network Management Protocol). In other words, the SNMP is used to manage all the devices of the network.

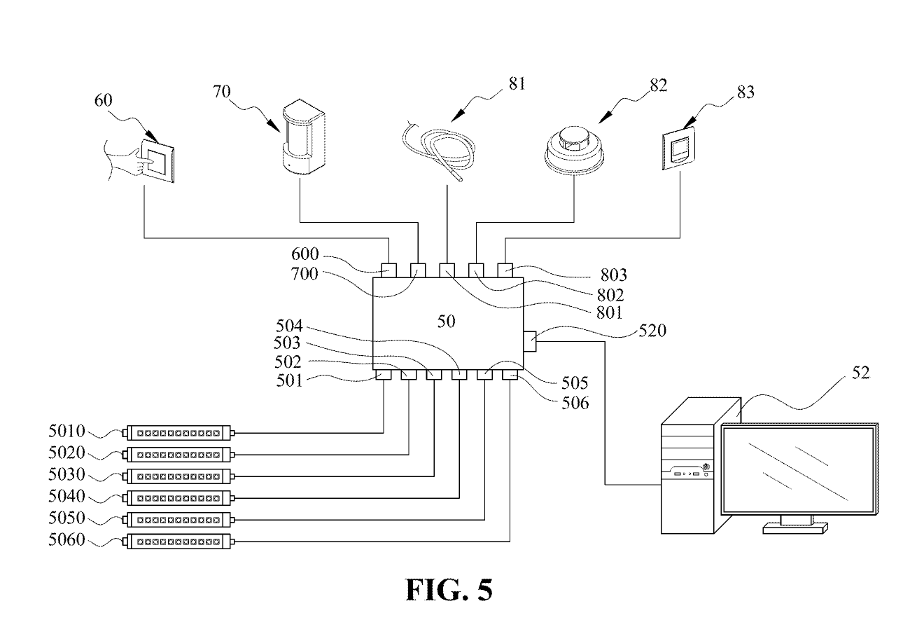

FIG. 5 illustrates the environmental management system according to the present invention in real application.

As shown, the environmental management system 50 of the present invention includes: a plurality of pulse width modulation devices 50 having a plurality pulse width modulation connection ports 501, 502, 503, 504, 505, 506, each pulse width modulation connection port 501, 502, 503, 504, 505, 506 is used for electrically coupled with a respective one of the LEDs 5010, 5020, 5030, 5040, 5050, 5060. The drawing shows how the LEDs of the environmental management system 50 are coupled with the background management module 52 via the network connection port 520.

In addition, in the environmental management system 50 of the present invention, the PIR digital connection port 600 is coupled electrically with the digital dimmer 60; the PIR object movement sensing port 700 is coupled electrically with the PIR object movement sensor 70; the RS485 connection port 801 is coupled electrically with the temperature sensing element 81; the RS485 connection port 802 is coupled electrically with the humidity sensing element 82 while the RS485connection port 803 is coupled electrically with air-quality sensing element 83, thereby establishing the entire environmental management system so as to control or monitor the brightness of the LEDs as well as the monitoring data of nearby environment.

Regarding operation of the system is given in the following paragraph. The operator can operate the background management module 52 in order to control the brightness or the color temperature of the LEDs 5010-5060, and later the background management module 52 can further integrate a certain suitable logic program for controlling the performance of the LEDs.

Note the illumination and/or the brightness of the LEDs is controlled by Pulse Width Modulation (PWM), one technique of variation of the lighting of LEDs.

The digital dimmer 60 is coupled electrically with the environmental management device 50 of the present invention via the pulse width connection port 600 such that an operator can operate the digital dimmer 60 in order to vary the brightness or the color temperature of the LEDs 5010-5060.

The PIR object movement sensor 70 is coupled electrically with the environmental management device 50 of the present invention via the PIR object movement sensing port 700 such that the object movement sensor 70 can transmit the sensing information to the background management module 52 for monitoring the brightness or the cooler temperature of the LEDs 5010-5060 in such a manner that a logic program can be integrated together for raising the entire brightness or a portion of some specific LEDs 5010-5060.

In addition, in one embodiment of the present invention, the RS485 connection ports 801, 802, 803 are coupled electrically and respectively with the temperature sensing element 81, the humidity sensing element 82 and the air-quality sensing element 83 such that the background management module 52 can monitor and detect the humidity, the temperature and the air quality of the environment.

A user can easily remotely control at least one of brightness and color temperature of the environment and a combination thereof, that is also can remotely monitor an environmental data. Further, so that the maintenance cost of the ambient light source can be reduced.

Although the present invention has been described with reference to the preferred embodiments thereof, it is apparent to those skilled in the art that a variety of modifications and changes may be made without departing from the scope of the present invention which is intended to be defined by the appended claims. In particular, various changes and modifications may be made to the components and/or arrangements of the subject matter set forth within the scope of the present disclosure, the drawings, and the scope of the appended claims. Alternative uses will be apparent to those skilled in the art in addition to variations and modifications in the components and/or arrangements.

What is claimed is:

1. An environmental management device comprising:
a network connection port for receiving a first pulse width modulation signal via an Internet; and
a plurality pulse width modulation connection ports coupled electrically with said network connection port, each pulse width modulation connection port being used for receiving said first pulse width modulation signal in order to control at least one brightness of at least one LED, at least two modulation connection ports of said plurality pulse width modulation connection ports being used to control at least one color temperature of said at least one LED,
wherein the Internet is selected from a group consisting of at least one cable network, at least one wireless network, and a combination thereof.

2. The environmental management device according to claim 1, further comprising a background management module for operation by at least one operator and generating the first pulse width modulation signal.

3. The environmental management device according to claim 2, wherein said background management module for operation by said at least one operator and generating a timing command such that performance of said at least one LED is controlled by said first pulse width modulation signal based on said timing command.

4. The environmental management device according to claims 1, further comprising a plurality of digital switch ports and a plurality of digital switches coupled electrically and respectively to said plurality of digital switch ports, each of said plurality of digital switch ports being used for receiving a second pulse width modulation signal generated by each of said plurality of digital switches.

5. The environmental management device according to claim 4, wherein each of said plurality pulse width modulation connection ports is used for receiving a respective one of said second pulse width modulation signals in order to control said at least one brightness of said at least one LED, at least two pulse width modulation connection ports of said plurality pulse width modulation connection ports being used to control said at least one color temperature of said at least one LED according to said second pulse width modulation signal.

6. The environmental management device according to claim 1, wherein said plurality pulse width modulation connection ports have several specifications comprising at least one of a digital dimming port, a PIR object movement sensing port, RS485, RS422, RS232, UART, CAN, LIN and I2C and a combination thereof

7. The environmental management device according to claim 6, wherein each of said plurality of pulse width modulation connection ports which compatible with at least one of the specifications RS485, RS422, RS232, UART, CAN, LIN, I2C and combinations thereof being electrically connected to at least one sensor which compatible with at least one of the specifications RS485, RS422, RS232, UART, CAN, LIN, I2C and combinations thereof, respectively, for causing said background management module to retrieve and monitor at least one monitoring data generated by said at least one sensor through said plurality of pulse width modulation connection ports.

8. An environmental management system comprising:
a network connection port for receiving a first pulse width modulation signal via the Internet;
a plurality pulse width modulation connection ports coupled electrically with said network connection port, each pulse width modulation connection port being used for receiving said first pulse width modulation signal in order to control at least one brightness of at least one LED, at least two pulse width modulation connection ports of said plurality pulse width modulation connection ports being used to control at least one color temperature of said at least one LED;
a background management module for operation by at least one operator and generating the first pulse width modulation signal; and
at least one sensor for causing said background management module to retrieve and monitor at least one monitoring data generated by said at least one sensor through said plurality of pulse width modulation connection ports,
wherein the Internet is selected from a group consisting of at least one cable network, at least one wireless network and a combination thereof

9. The environmental management system according to claim 8, wherein said background management module for operation by said at least one operator and generating a timing command such that performance of said at least one LED is controlled by said first pulse width modulation signal based on said timing command.

10. The environmental management system according to claim 8, further comprising a plurality of digital switch ports and a plurality of digital switches coupled electrically and respectively to said plurality of digital switch ports, each of said plurality of digital switch ports being used for receiving a second pulse width modulation signal generated by each of said plurality of digital switches.

11. The environmental management system according to claim 10, wherein each of said plurality pulse width modulation connection ports is used for receiving a respective one of said second pulse width modulation signals in order to control said at least one brightness of said at least one LED, at least two pulse width modulation connection ports of said plurality pulse width modulation connection ports being used to control said at least one color temperature of said at least one LED according to said second pulse width modulation signal.

12. The environmental management system according to claim 8, wherein said plurality pulse width modulation connection ports have several specifications comprising at least one of a digital dimming port, a PIR object movement sensing port, RS485, RS422, RS232, UART, CAN, LIN and I2C and a combination thereof

13. The environmental management system according to claim 12, wherein each of said plurality of pulse width modulation connection ports which compatible with at least one of the specifications RS485, RS422, RS232, UART, CAN, LIN, I2C and combinations thereof being electrically connected to at least one sensor which compatible with at least one of the specifications RS485, RS422, RS232, UART, CAN, LIN, I2C and combinations thereof, respectively, for causing said background management module to retrieve and monitor at least one monitoring data generated by said at least one sensor through said plurality of pulse width modulation connection ports.

14. An environmental management method, comprising:
operating by at least one operator and generating a first pulse width modulation signal;
receiving said first pulse width modulation signal through the Internet;
receiving said first pulse width modulation signal in order to control at least one brightness and at least one color temperature of at least one LED; and
acquiring monitoring data for monitoring said at least one LED.

15. The environmental management method according to claim 14, further comprising a background management module for operation by at least one operator and generating the first pulse width modulation signal.

16. The environmental management method according to claim 15, wherein said background management module for operation by said at least one operator and generating a timing command such that performance of said at least one LED is controlled by said first pulse width modulation signal based on said timing command.

17. The environmental management method according to claim 14, further comprising: receiving a second pulse width modulation signal in order to control at least one brightness and at least one color temperature of said at least one LED.
